(19) United States
(12) Patent Application Publication
(10) Pub. No.: US 2004/0224678 A1
(43) Pub. Date: Nov. 11, 2004

(54) Reduced latency in half-duplex wireless communications

(75) Inventors: Ashraf M. Dahod, Andover, MA (US); Michael Silva, East Sandwich, MA (US)

Correspondence Address: WILMER CUTLER PICKERING HALE AND DORR LLP, 60 STATE STREET, BOSTON, MA, 02109, US

(73) Assignee: Starent Networks, Corp.

(21) Appl. No.: 10/431,818

(22) Filed: May 8, 2003

(51) Int. Cl. H04Q 7/20

(52) U.S. Cl. 455/426.1; 455/422.1

(57) ABSTRACT

A system and method for reducing the latency or apparent latency of half-duplex (e.g. push-to-talk “PTT” wireless communications, including storing a voice message or a portion thereof while establishing a real-time half-duplex communication session to minimize the initial wait time experienced by the PTT session originator.

### TECHNICAL FIELD

The present application relates to wireless mobile communications. More particularly, the present application features reducing latency or apparent latency in half-duplex communication systems such as push-to-talk (PTT) communication systems.

### BACKGROUND

Wireless communication devices, such as cellular telephones provide simultaneous two-way (bi-directional) communication, also called full-duplex communication, between two or more parties. In full-duplex mode both parties can talk at the same time and be heard. Some cellular telephone systems also permit half-duplex communication. Half-duplex communication is communication in which one party transmits while the other party receives. In half-duplex communication a party cannot be transmitting and receiving at the same time, or in other words, only one party can talk at any given moment and be heard.

Push-to-talk (PTT) wireless handheld devices allow users to exploit special communication frequencies in half-duplex communication mode, which are convenient for exchanging brief communications similar to those obtained using walkie-talkies. Push-to-talk communication systems employ dedicated wireless communication infrastructures that generally provide a longer range and higher quality than traditional walkie-talkie systems. Special PTT mobile devices are sold, for example, by Nextel Communications and others, who provide PTT functionality as a feature of their cellular telephones.

In a typical implementation, a PTT communication session is originated by an originating sender who presses a special PTT button on his or her wireless device. Depending on the wireless device configuration, a selected recipient or group of recipients is then connected in real-time to the sender. Once a connection is established between the sender and the recipients of a PTT communication, the sender receives a confirmation signal, such as an audible chirp, which indicates that the sender may communicate with the recipients in real-time. The sender then speaks into the device and the half-duplex voice signal is heard by the connected PTT recipients. Once a PTT communication session is established, any participant can become a sender and the others become recipients of that participant's half-duplex communication message. When the original sender is finished speaking, the sender releases or toggles the PTT button, to indicate that the sender has finished transmitting and is ready to receive. At this point, another participant can actuate his or her own PTT transmit button, receiving a confirmation chirp, and contribute to the PTT session while the original sender listens.

A finite delay time, or latency, exists between the time the originating sender presses the PTT button until the originating sender receives a confirmation or a “go ahead” response from the system (e.g., the audible chirp) indicating that the originating sender may begin speaking his or her half-duplex voice message. In special-purpose PTT communication systems having dedicated half-duplex communication frequencies, this latency is typically about 1-5 seconds. Such a delay is considered acceptable to PTT system users, and in many instances, is still faster and more convenient than establishing a conventional telephone conference call or dialing a telephone number in the traditional sense.

However, as indicated briefly above, present PTT communication systems require dedicated PTT communication channels and infrastructure to ensure acceptable performance. Most current wireless or cellular telephones only provide full-duplex communication and lack half-duplex communication capability such as PTT communication. Present full-duplex wireless systems have not been efficiently or practically used as half-duplex communication systems, in part because of the relatively long time required to establish real-time communication links between two or more wireless users in present full-duplex communications. Such delay times are referred to as latency periods and are typically upwards of 13 to 18 seconds using current wireless communication infrastructures.

### SUMMARY

One or more embodiments described herein provide method for reducing apparent latency in half-duplex wireless communications. One embodiment features receiving a request signal from a first wireless device indicating that a half-duplex communication link is to be established with a second wireless device; returning a response signal to the first wireless device indicating that the system is ready to accept a half-duplex voice signal from the first wireless device; receiving the half-duplex voice signal from the first wireless device; electronically storing the half-duplex voice signal; sending the half-duplex voice signal to the second wireless device; and establishing a real-time half-duplex communication link between the first and second wireless devices.

Other embodiments are directed to a system for providing a half-duplex communication session between a first wireless device and a second wireless device, having a communication network, coupled to the first and second wireless devices, that carries voice communication signals between the first and second wireless devices; an encoder, coupled to the communication network, that receives a half-duplex voice signal from the first wireless device and generates an encoded audio file corresponding to the half-duplex voice signal; a storage device coupled to the encoder that stores the encoded audio file; a decoder, coupled to the storage device, that decodes the stored audio file and generates a corresponding playback signal; and a controller that controls the half-duplex communication session, including establishing a connection to the second wireless device, delivering the playback signal to the second wireless device, and establishing a real-time half-duplex communication link between the first and second wireless devices.

Yet other embodiments are directed to a method for reducing apparent latency in a half-duplex wireless communication system, featuring receiving a request signal from a first wireless device indicating that a push-to-talk (PTT) communication link is to be established with a second wireless device; returning a response signal to the first wireless device indicating that the system is ready to accept a PTT voice signal from the first wireless device; receiving the PTT voice signal from the first wireless device; encoding the received voice signal as a digital audio file; electronically storing the digital audio file; establishing a communication link with the second wireless device; decoding the stored digital audio file; sending the decoded digital audio file to the second wireless device; and establishing a real-time half-duplex communication link between the first and second wireless devices.

Still another embodiment features a system for providing a half-duplex communication session between a first wireless device and a second wireless device, having an infrastructure for full-duplex communication, coupled to the first and second wireless devices, that carries voice communication signals between the first and second wireless devices; an encoder for encoding the voice communication signals, coupled to the communication network, that receives a half-duplex voice signal from the first wireless device and generates an encoded audio file corresponding to the half-duplex voice signal; a storage device for storing the encoded audio file, coupled to the encoder; a decoder for decoding the stored audio file, coupled to the storage device, that decodes the stored audio file and generates a corresponding playback signal; and a controller for controlling the half-duplex communication session, including establishing a connection to the second wireless device, delivering the playback signal to the second wireless device, and establishing a real-time half-duplex communication link between the first and second wireless devices.

Another embodiment provides a method for reducing apparent latency in a half-duplex communication session over a full-duplex communication system infrastructure, the method featuring dividing a total latency in establishing a real-time half-duplex communication session into at least two parts: a first part covering a time period from the time a request for the half-duplex session is made until a confirmation response is provided to a maker of the request; and a second part covering a time period from the time when the confirmation response is provided to the maker of the request until the time at which the real-time half-duplex communication session is established.

### BRIEF DESCRIPTION OF THE DRAWINGS

For a fuller understanding of the present disclosure, reference is made to the following detailed description taken in conjunction with the accompanying drawings in which:

FIG. 1 illustrates a communication system according to an exemplary embodiment;

FIG. 2 illustrates a comparative time line for the present system and method and other PTT systems and methods, showing a reduced initial latency;

FIG. 3 illustrates a method for half-duplex communication from the perspective of the communication system;

FIG. 4 illustrates a method for half-duplex communication from the perspective of an originating sender; and

FIG. 5 illustrates a method for half-duplex communication from the perspective of a recipient.

### DETAILED DESCRIPTION

As explained above, current full-duplex wireless communication systems have not provided acceptable half-duplex communications comparable to those available with dedicated PTT systems due to the unacceptably-long latency currently associated with establishing connections between senders and receivers. In other words, the long latency associated with establishing a real-time communication link between the originating sender and the recipients makes half-duplex communication over most wireless networks impractical. The experience of the originating sender attempting to establish a PTT-style connection with the recipients is considered unacceptable, as the sender must wait up to 18 seconds before the real-time connection is established so that the sender may begin transmitting his or her message.

According to some aspects of the present application, the perceived latency experienced by the original sender is reduced by acknowledging the originating sender's request and accepting the sender's voice message prior to fully establishing a real-time connection between the sender and the recipients. As will be explained in more detail below, a sender's request to send a half-duplex voice message is promptly acknowledged by the wireless system and the sender is provided with a response signal, such as a PTT chirp tone, indicating that the sender may begin speaking even before a recipient is connected to the sender. In one or more embodiments, this is accomplished by buffering the original half-duplex voice signal sent by the sender, and storing the voice signal electronically while simultaneously establishing real-time connections to the recipients. The stored voice signal is delivered to the recipients once a connection to the recipients is established, and the original sender is connected to the recipients in a real-time half-duplex communication mode which is similar in many respects to other PTT communication modes. Note that the buffering may be of the entire initial voice signal or merely a portion thereof.

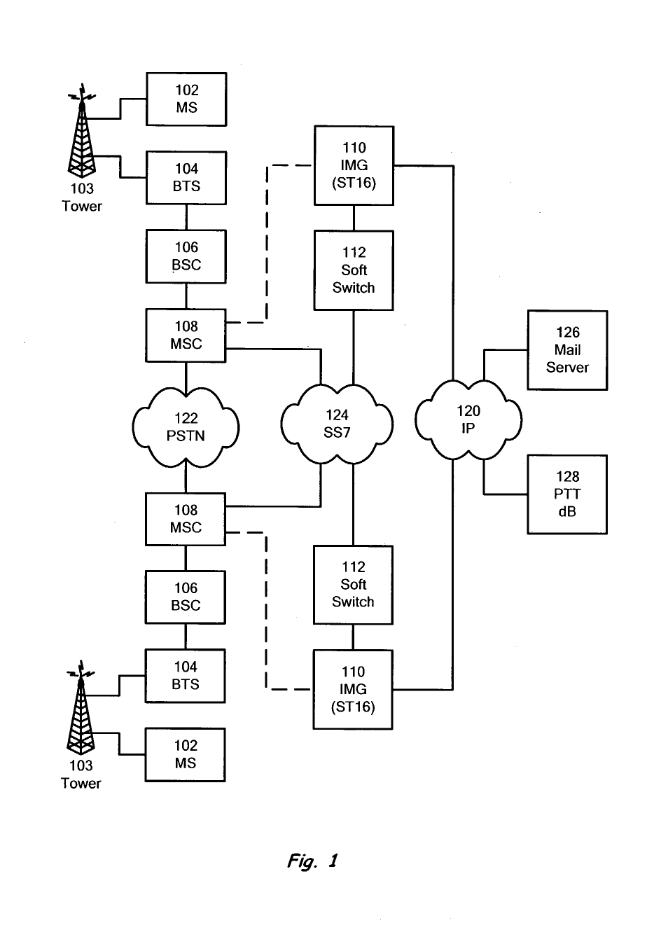

FIG. 1 illustrates a schematic diagram of a communication system in which two mobile stations or wireless devices 102 communicate with one another. Specifically, each wireless device 102 communicates with a respective base transceiver station (BTS) 104 through an antenna tower 103 covering the cell or geographic area (cell) in which the wireless device 102 is located. The BTS 104 includes hardware and processing circuits capable of covering a particular cell and interacting with the wireless devices 102 within the cell. The BTS 104 is itself coupled to a base station controller (BSC) 106 which administers a plurality of BTSs 104 for calls to units outside or within the same calling cell.

The communication hierarchy also includes a mobile switching center (MSC) 108 which administers a plurality of BSCs 106. The MSC 108 acts as a local switching exchange, and communicates with the public switched telephone network (PSTN) 122. The MSC 108 and the PSTN 122 are connected through voice trunk groups. The PSTN 122 carries voice and other signals in analog form over copper wire. These signals are frequently referred to as plain old telephone service (POTS) communications.

The International Telephony Union (ITU) has adopted a standard known as Signaling System 7 (SS7) which allows offloading congested PSTNs by using high-speed bi-directional out-of-band SS7 nodes to take on traffic from PSTN networks and move it along digital broadband channels. Therefore, MSC 108 is also coupled to SS7 network 124 to handle control functions, e.g., setting up and taking down calls.

One other network for moving information is the Internet, which uses the Internet Protocol and is illustrated in FIG. 1 as IP 120. This network can carry digital data including voice signals according to numerous formats, including voice over IP (VoIP).

MSC 108 is coupled to a soft switch 112 that includes an application programming interface (API) used to bridge traditional PSTN 122 and IP 120 networks. Soft switch 112 can manage traffic containing many types of data, such as voice, fax, numeric, data, video, etc. Generally, soft switch 112 directs the packet traffic and is flexible enough to process signaling for all types of packet protocols. Therefore, soft switch 112 can be considered a software-based switching platform which in some aspects performs a similar function to a traditional hardware-based switching center.

In the embodiment illustrated by FIG. 1, an Internet media gateway (IMG 110), such as the ST16 from Starent Networks, is disposed between the soft switch 112 and the SS7 network 124. The IMG 110 performs a plurality of functions and can communicate over the Internet and controls messaging functions such as performed by mail server 126. The IMG serves its corresponding mobile station or wireless device 102, and provides the wireless device 102 with access to enhanced features such as those described in co-pending U.S. patent application Ser. No. 10/210,897, filed Aug. 1, 2002, entitled Providing Advanced Communications Features, which is hereby incorporated by reference. The IMG 110 contains a media server (MS) and other hardware and/or software elements.

The MSC 108 and the IMG 110 are shown connected by dashed lines to indicate that in some embodiments the MSC 108 is implemented as part of the IMG 110.

One function which is provided by the IMG 110 according to the present disclosure is a half-duplex or push-to-talk (PTT) feature. The IMG 110 electronically stores the voice message sent by the originating sender from a first wireless device 102. The voice message is preferably encoded, e.g. as a WAV file, and stored in a digital storage medium such as a hard disk or tape drive or optical storage mechanism or any other mechanism suitable for storing a representation of the message. The IMG 110 then coordinates decoding, playback and delivery of the stored message over any network, including IP network 120, to its intended recipients. In this way, the originating sender is not required to wait until a real-time communication link is established between the sender and a recipient's wireless devices, but may begin speaking promptly after requesting a half-duplex communication link and receiving a “go ahead” response signal from IMG 110.

In the present exemplary embodiment, a method for reducing the wait time or apparent latency experienced by an originating sender in half-duplex communications is provided. First, the originating sender sends a request signal from his or her wireless device indicating that a half-duplex communication link is to be established with a second user (recipient) or a second wireless device. Upon receiving the sender's request signal, IMG 110 promptly, and without waiting to establish a real-time connection with the desired recipient, returns a response signal to the sender's wireless device indicating that the system is ready to accept a half-duplex communication message from the sender's wireless device. The response signal may generate an audible tone or chirp, such as those generated in push-to-talk (PTT) systems, to indicate that the system is ready to receive a voice message from the sender. Once the response signal has been received at the sender's wireless device, the first wireless device may deliver a voice message through BTS 104, BSC 106, and MSC 108, as described earlier. The voice signal is delivered to IMG 110, which stores the voice signal as a digital file such as a WAV format digital audio file.

Meanwhile, IMG 110 is directing that a real-time half-duplex communication link be established between the sender and the recipient or group of recipients. Once a connection is established to the intended recipient or group of recipients, the stored voice signal is relayed to the recipients and played back by decoding the stored digital audio file. At this time, the real-time half-duplex communication link between the original sender and the other participants in the half-duplex communication session proceeds without undue time delays.

Therefore, by accepting the original sender's voice signal promptly, and by not waiting until the real-time communication link is established with the recipients, the original sender does not experience an undue excessive wait time before starting the half-duplex communication session. Also, the recipients of the original voice signal are unaffected by the fact that the voice signal was temporarily stored while the connection to the recipients was being established. Accordingly, the infrastructure now used for full-duplex wireless communications may be used to achieve acceptable half-duplex (PTT) communications without an impractical or excessively long wait time experienced by the original sender in a half-duplex communication session.

Present tests indicate that a reduced latency of only 3 to 5 seconds is achievable in a half-duplex communication session according to that presented herein, compared with best-case scenarios of 11 to 13 seconds without implementing the techniques described herein.

A closer analysis of the latency in wireless communication systems is presented next. Latency in wireless communication systems may be considered a sum of several contributing factors or events, each contributing to the total latency or time delay experienced by the user of the wireless communication system. Assume that t₁ is the time period from the moment the user pushes a PTT button on a wireless device until the request signal reaches the IMG 110 or media server servicing that wireless device. The time period from initiating a response signal by the IMG 110 until its receipt at the wireless device 102 indicating that the originator may begin half-duplex voice communication is called t₂. The time period required to establish the half-duplex communication session among all applicable participants, once the sender's request is received by IMG 110, is called t₃. This includes the time to open a communication link to the recipient's wireless devices and alert the recipients to an incoming half-duplex message as well as the time required for the users of the recipient devices to answer the call to establish the half-duplex communication session.

Typical delays in present communication infrastructures accord t₁ a delay of approximately 4 seconds; t₂ approximately 1 seconds using a ST16 platform, depending on the number of users or groups being contacted; and t₃ approximately 6 to 10 seconds, depending on how fast the recipient participants answer their calls. Therefore, without using the latency reduction method of the present application, a total latency (t₁+t₂+t₃) may be approximately 11 to 15 seconds. This latency is unacceptable to average users, who will become impatient or confused by the long delay and may choose another communication methodology, such as text messaging, short message service (SMS), instant voice messaging (VIM) or another real-time or non real-time communication method. It can be appreciated from these approximate delay times that an original outgoing voice message of several seconds' duration can be stored or buffered while the real-time connections to the recipients are being established.

Depending on the particular implementation and network architecture, and depending on the performance characteristics desired, the original sender's stored voice signal may be of some minimum time duration to improve the smoothness or quality experienced by the receiving participants in the half-duplex communication session. That is, a controllable minimum length may be imposed on the stored voice signal to mask the transition from playback mode to real-time communication. This time may be accomplished by buffering shorter messages with other content, or silence, for example.

Even if only one recipient is designated, a very fast connection is obtained, and the one recipient answers the call very quickly, it is possible to use the method described herein. A variable or programmable voice message length is stored, which can be arbitrarily short or long depending on the expected connection delay times. If the original sent message is shorter than a minimum length, the message may be padded appropriately to achieve the desired minimum length.

In some embodiments, if a recipient or group of recipients do not answer the half-duplex call sent by the sender, the stored message may simply be deleted or expires and the message is lost. In other embodiments, the stored message is saved as a voice mail message. The originating sender is notified by any convenient method such as a voice or audible message or a text message sent to the sender's wireless device that the message was not delivered.

Since the IMG 110 provides a storage capability, multiple users in half-duplex communications may communicate asynchronously. That is, it is not necessary in all cases to ever establish a real-time connection between the participants, but rather, a communication session may be carried out where multiple segments of voice from multiple speakers are stored and re-transmitted to the appropriate parties at the correct sequential times.

A database 128 is coupled to the communication network. The database 128 stores data and information such as lists of users and telephone numbers. For example, two or more users can be grouped together, allowing a half-duplex session involving the members of the group and saving the originator from having to dial each member of the group individually. One application for this arrangement is when a team of workers are in the field working on a project and have a need for half-duplex communication among all members of the team.

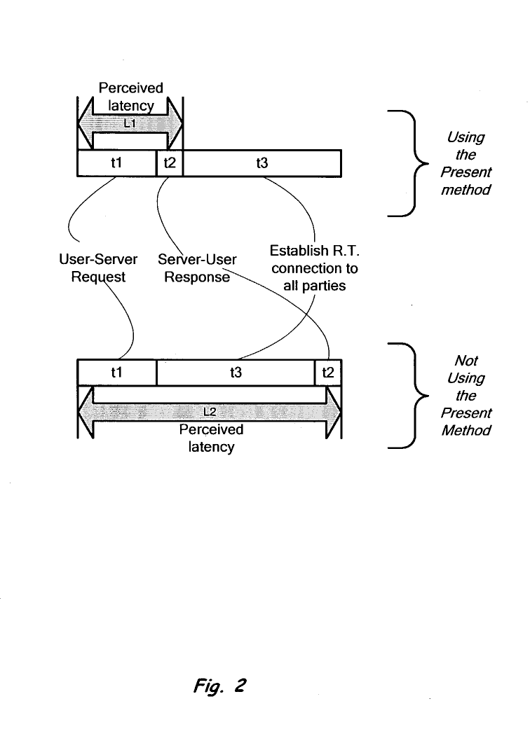

FIG. 2 illustrates a time line showing that the perceived latency or initial wait time until the originating sender can start delivering his or her voice message signal is shorter according to the present disclosure than in other PTT systems and methods. Specifically, the present embodiment shown in FIG. 2 gives the apparent latency perceived by the originating sender according to the present disclosure as L1=t₁+t₂. This is shorter than the apparent latency according to other PTT systems using full-duplex infrastructures (e.g. cellular telephone systems), in which the apparent latency L2=t₁+t₃+t₂.

Apparent latency in a half-duplex communication session over a full-duplex communication system infrastructure can thus be reduced by dividing a total latency in establishing a real-time half-duplex communication session into two parts: a first part (t₁+t₂), indicated at L1 in FIG. 2, spanning the time period from the time a request for the half-duplex session is made until a confirmation response is provided to a maker of the request; and a second part spanning the time period from the time when the confirmation response is provided to the maker of the request until the time at which the real-time half-duplex communication session is established. Current systems require a half-duplex sender in a full-duplex system to wait the entire latency time, L2 in FIG. 2, which is unacceptable to users and providers of the service.

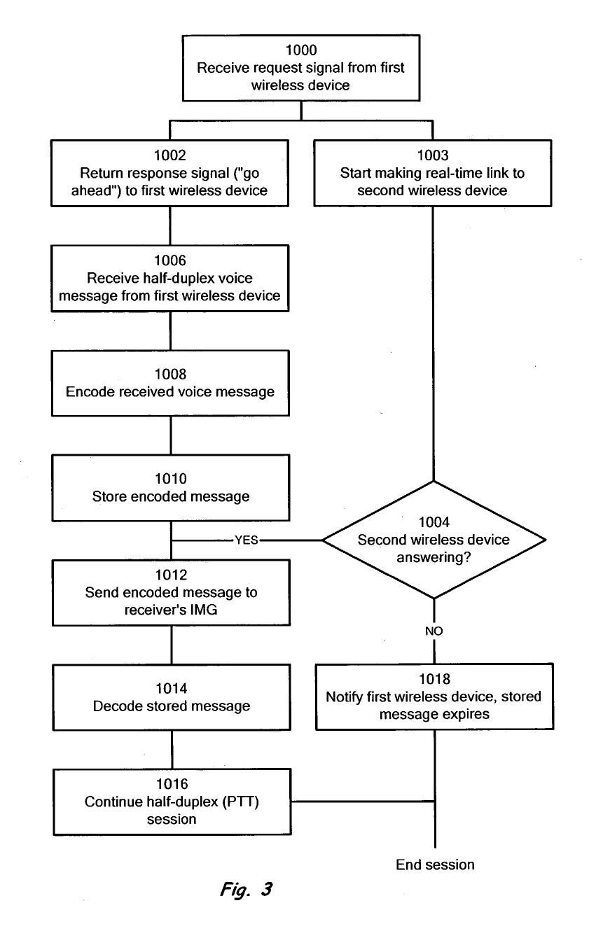

FIG. 3 is a flow chart illustrating steps of a method for half-duplex communication according to an embodiment of the present disclosure. The method depicted in FIG. 3 is given from the perspective of the wireless communication system. More particularly, the method is presented from the perspective of IMG 110.

At step 1000, the system receives a request signal from a first wireless device 102. In step 1002, the system returns a response signal, or a “go-ahead” signal to the first wireless device. The response signal is an acknowledgment and indication that the first wireless device may begin transmitting a voice message. The response signal may be an audible signal such as a chirp or a text message, e.g. “Ready to send,” etc. Substantially simultaneously with step 1002, the system begins the process of establishing a real-time link to a recipient second wireless device (or plural devices) in step 1003. As described earlier, the user of the first wireless device begins sending a half-duplex voice message which is received by the system in step 1006.

The system may optionally encode the received voice message in step 1008. Such encoding may include acts of compression, encryption, or other techniques carried out in software and/or hardware to encode the received voice message into a desired format. The encoded message is stored in step 1010, electronically, such as by saving the message as a digital audio file in a computer storage medium.

In step 1004, it is determined whether the recipient second wireless device has accepted or answered the half-duplex communication. If the recipient second wireless device does not answer, then the “NO” branch is followed and the first wireless device sender is notified in step 1018 that the session has failed and the stored voice message expires. The expired voice message may be deleted or may be saved as a voice mail message as described elsewhere in this application.

A SMS notification message is delivered in some embodiments to the sender of the message indicating the status of a voice instant message (VIM), for example indicating it was delivered, listened to, discarded, etc. Also, the recipient of the VIM may be notified of the arrival of the VIM and other associated information. The recipient may choose to accept, delete, forward, or otherwise act on the incoming VIM in light of the SMS notification message. This technology can be integrated with other communication features such as PTT systems.

On the other hand, if the second wireless device does answer and accepts the call in step 1004, then the “YES” branch is followed and the stored encoded message from step 1010 is sent to the second wireless device in step 1012. The encoded message is then decoded at the receiver's IMG in step 1014. Decoding the stored message may involve decompressing, decrypting, or other manipulation of the stored message to convert it into a proper format for playback to the desired recipient.

At this point, in step 1016, the half-duplex communication session may proceed such as a PTT communication session in the normal way.

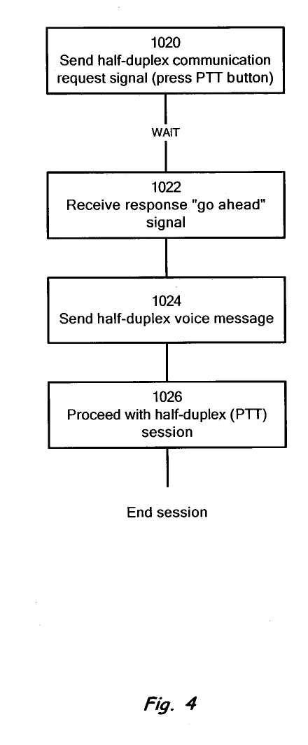

FIG. 4 illustrates a sequence of steps in the method from the point of view of the originating sender or the first wireless device 102. Initially, the first wireless device 102 sends a half-duplex communication request signal, such as by actuating a PTT button or sequence of buttons on the first communication device in step 1020. The originating sender or user of the first wireless device must wait for a response (“go ahead”) signal from the system which is received in step 1022. The wait-time is the latency experienced by the originating sender which is preferably short. Once the first wireless device is cleared to begin communication, the originating sender sends his or her half-duplex voice message to the system in step 1024. Then in step 1026, the originating sender proceeds with the half-duplex (PTT) communication session as normal.

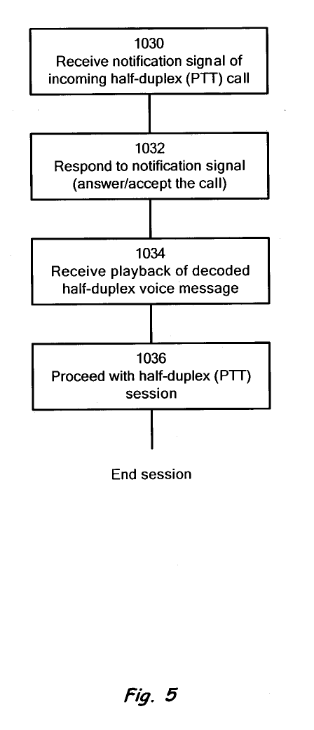

FIG. 5 illustrates the method discussed above from the point of view of a recipient in a half-duplex communication session. In step 1030, the recipient or second wireless device receives a notification signal of an incoming half-duplex (PTT) call. This may be in the form of a ringing or an other audible tone, a text indication, vibration of the wireless device, or other signaling notification. The user of the second wireless device (recipient) responds to the notification signal by accepting or answering the incoming call in step 1032. The recipient's response may include pressing a key or code to differentiate a live personal acceptance of the incoming cell from an automated/machine (e.g. voice mail) response. In step 1034, the second wireless device receives a played back version of the previously stored and now decoded half-duplex voice message. Note that the recipient of the decoded message generally will not notice the difference between the played back message and a traditional half-duplex (PTT) voice signal which is relayed in real-time. In step 1036, the recipient device proceeds with the half-duplex (PTT) session as normal. Therefore, the user experience of a recipient of a half-duplex communication according to the present disclosure is preferably unencumbered by the intermediate encoding and storing of the originating sender's voice signal.

It should be appreciated that the systems and concepts described herein apply not only to voice communication, but may also apply to other types of communication carried over half-duplex systems, such as data or text messaging communications. Additionally, numerous communications and telephony functions and features may be included in the systems or methods described herein. For example, a soft-button user interface may be implemented on touch screens in the wireless devices to call or otherwise access the half-duplex communication sessions. Voice controls may be used, wherein speech recognition software in the wireless devices or at a controller in the communication system recognizes spoken commands and carries out a corresponding task.

Upon review of the present description and embodiments, those skilled in the art will understand that modifications and equivalent substitutions may be performed in carrying out the invention without departing from the essence of the invention. Thus, the invention is not meant to be limited by the embodiments described explicitly above, rather it should be construed by the scope of the claims that follow.

What is claimed is:

1. A method for reducing apparent latency in a half-duplex wireless communication system, comprising:
receiving a request signal from a first wireless device indicating that a half-duplex communication link is to be established with a second wireless device;
returning a response signal to the first wireless device indicating that the system is ready to accept a half-duplex voice signal from the first wireless device;
receiving the half-duplex voice signal from the first wireless device;
electronically storing the half-duplex voice signal;
sending the half-duplex voice signal to the second wireless device; and
establishing a real-time half-duplex communication link between the first and second wireless devices.

2. The method of claim 1, wherein the response signal is returned prior to establishing the real-time communication link between the first and second wireless devices.

3. The method of claim 1, wherein the half-duplex wireless communication is push-to-talk (PTT) communication.

4. The method of claim 1, further comprising encoding the received half-duplex voice signal as a digital audio file prior to storing the signal.

5. The method of claim 1, further comprising decoding the stored signal prior to sending the signal to the second wireless device.

6. The method of claim 1, wherein the half-duplex communication takes place over a cellular communication channel.

7. The method of claim 1, wherein the half-duplex communication is packet-switched voice over Internet protocol (VoIP).

8. The method of claim 1, wherein the apparent latency is less than the time required to establish the real-time communication link between the first and the second wireless devices.

9. The method of claim 1, wherein the half-duplex communication link also includes a third wireless device.

10. A system for providing a half-duplex communication session between a first wireless device and a second wireless device, comprising:
a full-duplex communication network, coupled to the first and second wireless devices, that carries voice communication signals between the first and second wireless devices;
an encoder, coupled to the communication network, that receives a half-duplex voice signal from the first wireless device and generates an encoded audio file corresponding to the half-duplex voice signal;
a storage device coupled to the encoder that stores the encoded audio file;
a decoder, coupled to the storage device, that decodes the stored audio file and generates a corresponding playback signal; and
a controller that controls the half-duplex communication session, including establishing a connection to the second wireless device, delivering the playback signal to the second wireless device, and establishing a real-time half-duplex communication link between the first and second wireless devices.

11. The system of claim 10, wherein any of the first and second wireless devices comprise a cellular telephone.

12. The system of claim 10, wherein the half-duplex communication session is a push-to-talk (PTT) session.

13. The system of claim 10, wherein the controller comprises an Internet media gateway (IMG).

14. The system of claim 10, wherein the communication network comprises any of: a telephone network, a broadband network and an Internet connection.

15. The system of claim 10, further comprising the first wireless device, wherein the first wireless device includes a memory and a processor that executes instructions stored in the memory.

16. A method for reducing apparent latency in a half-duplex wireless communication system, comprising:
receiving a request signal from a first wireless device indicating that a push-to-talk (PTT) communication link is to be established with a second wireless device;
returning a response signal to the first wireless device indicating that the system is ready to accept a PTT voice signal from the first wireless device;
receiving the PTT voice signal from the first wireless device;
encoding the received voice signal as a digital audio file;
electronically storing the digital audio file;
establishing a communication link with the second wireless device;
decoding the stored digital audio file;
sending the decoded digital audio file to the second wireless device; and
establishing a real-time half-duplex communication link between the first and second wireless devices.

17. A system for providing a half-duplex communication session between a first wireless device and a second wireless device, comprising:
means for full-duplex communication, coupled to the first and second wireless devices, that carries voice communication signals between the first and second wireless devices;
means for encoding the voice communication signals, coupled to the communication network, that receives a half-duplex voice signal from the first wireless device and generates an encoded audio file corresponding to the half-duplex voice signal;
means for storing the encoded audio file, coupled to the encoding means;
means for decoding the stored audio file, coupled to the storage means, that decodes the stored audio file and generates a corresponding playback signal; and
means for controlling the half-duplex communication session, including establishing a connection to the second wireless device, delivering the playback signal to the second wireless device, and establishing a real-time half-duplex communication link between the first and second wireless devices.

18. A method for reducing apparent latency in a half-duplex communication session over a full-duplex communication system infrastructure, the method comprising dividing a total latency in establishing a real-time half-duplex communication session into at least two parts: a first part substantially comprising a time period from the time a request for the half-duplex session is made until a confirmation response is provided to a maker of the request; and a second part substantially comprising a time period from the time when the confirmation response is provided to the maker of the request until the time at which the real-time half-duplex communication session is established.

19. The method of claim 18, further comprising receiving a half-duplex voice signal from the maker of the request following the first part.

20. The method of claim 19, further comprising storing the half-duplex voice signal in a storage device.

21. The method of claim 20, further comprising delivering the stored signal to a recipient prior to establishing the real-time half-duplex communication session.
